(19) United States
(12) Patent Application Publication
(10) Pub. No.: US 2015/0329137 A1
(43) Pub. Date: Nov. 19, 2015

(54) CONDITIONED STEERING WHEEL

(71) Applicant: Gentherm Canada Ltd., Windsor (CA)

(72) Inventor: Madalina Onica, Windsor (CA)

(21) Appl. No.: 14/709,796

(22) Filed: May 12, 2015

Related U.S. Application Data
(60) Provisional application No. 61/992,515, filed on May 13, 2014.

(51) Int. Cl. B62D 1/06

(52) U.S. Cl. CPC B62D 1/065

(57) ABSTRACT

A conditioned steering wheel comprising: (a) a heater and (b) a ventilation system including: (i) a distribution system and (ii) one or more blowers in communication with the distribution system; (iii) a blower hood, blower hood attachment, or both connected to and extending between one or more of the one or more blowers and the distribution system so that air is moved between the distribution system and the one or more blowers; wherein the steering wheel has a center and the one or more blowers are located outside of the center of the steering wheel.

### FIELD

The present teachings generally relate to a heated and ventilated and/or actively cooled steering wheel.

### BACKGROUND

The present teachings are predicated upon providing a steering wheel that is heated and ventilated and/or actively cooled. Attempts have been made to provide heating and cooling to steering wheels. Typical steering wheel heaters include one or more lay wires that are integrated into the steering wheel and upon application of electrical power the resistive lay wires generate heat. Some attempts have been made to cool steering wheels; however, due to the limited packaging space of the steering wheel these devices may have a limited air movement, limited available power capabilities, or both so that very little air is moved and little cooling effect is experienced by a user. The steering wheel cooling devices typically cool less than the entire circumference of the steering wheel such that a user will only feel a cooling sensation when the user is in contact with certain specific locations. Further, the heating and/or cooling elements cannot interfere with steering wheel control of a vehicle which limits the connection locations and area where components may be placed within the steering wheel. Attempts have been made to remotely locate the conditioning elements and move conditioned fluids into the steering wheel to provide cooling, however, these designs are limited by the packaging space available to provide cooling fluids for cooling. Finally, any heating and/or cooling elements need flexibility to accommodate movement of the steering wheel.

Examples of attempts to heat steering wheels may be found in U.S. Pat. Nos. 6,093,908; 6,414,270; 6,172,342; 7,109,261; and 7,145,102 all of which are incorporated by reference herein in their entirety for all purposes. Examples of attempts to cool steering wheels may be found in U.S. Pat. Nos. 5,850,741; 6,007,420; 6,298,750; and 6,533,184; U.S. Patent Application Publication No. 2004/0168540; Japanese Patent No. JP62-128879, and German Patent No. DE9111356 all of which are incorporated by reference herein in their entirety for all purposes.

It would be advantageous to have a steering wheel that is both heated and cooled around an entire circumference. It would be advantageous to have a heated and cooled steering wheel that is responsive so that heating and/or cooling may provide rapid results (i.e., less than 1 minute). What is needed is a heated and/or cooled steering wheel that provides thermal conditioning within the limited packaging space of the steering wheel without having to locate cooling components external to the steering wheel.

### SUMMARY

The present teachings meet one or more (if not all) of the present needs by providing a conditioned steering wheel comprising: (a) a heater and (b) a ventilation system including: (i) a bag and (ii) a plurality of blowers in communication with the bag.

The teachings provide a conditioned steering wheel comprising: (a) a heater and (b) a ventilation system including: (i) a distribution system and (ii) one or more blowers in communication with the distribution system; (iii) a blower hood, blower hood attachment, or both connected to and extending between one or more of the one or more blowers and the distribution system so that air is moved between the distribution system and the one or more blowers; wherein the steering wheel has a center and the one or more blowers are located outside of the center of the steering wheel.

The teachings herein provide: a conditioned steering wheel comprising: (a) a heater and (b) a ventilation system including: (i) one or more blowers, (ii) one or more channels that extend through one or more layers in the steering wheel and are in communication with the one or more blowers, one or more ventilation holes that distribute air from the one or more blowers, one or more channels, or both to a predetermined location

The teachings herein provide: a method comprising: (a) connecting a ventilation system to a body of a steering wheel; (b) connecting a bag to an inner rim of the steering wheel; and (c) connecting a plurality of blowers each to a blower hood, a blower hood attachment, or both so that air from the blower is moved through the ventilation system.

A method comprising: (1) connecting at least a portion of a ventilation system to a steering wheel; (2) connecting a distribution system to a rim, spokes, or both of the steering wheel; (3) connecting a plurality of blowers each to a blower hood, a blower hood attachment, or both so that air from the blower is moved through the ventilation system and the distribution system to a location of interest; and (4) wrapping a heater around at least a portion of the ventilation system, the distribution system, the rim, or a combination thereof; wherein the steering wheel has a center and the one or more blowers are located outside of the center of the steering wheel.

The teachings herein provide one or more of the following features: wherein the foam layer is a reticulated foam layer; wherein the bag includes opposing sealed edges that are air impermeable; wherein the ventilation system is wrapped around and connected to an inner rim; wherein the ventilation system, the distribution system, or both are connected to the inner rim by an adhesive; wherein the ventilation system is electrically connected to a power source via a plurality of power wires; wherein the channels, the ventilation holes, or both extend around a circumference of the steering wheel so that the entire steering wheel is cooled; wherein a heater is extended over the distribution system; wherein a trim layer is extended over the heater, the ventilation system, the distribution system, or a combination thereof;

The teachings herein surprisingly solve one or more of these problems by providing a steering wheel that is both heated and cooled around an entire circumference, or at least a substantial portion of the circumference. The present teachings provide a heated and cooled steering wheel that is responsive so that heating and/or cooling may provide rapid results (i.e., less than 1 minute). The present teachings provide a heated and/or cooled steering wheel that provides thermal conditioning in within the limited packaging space of the steering wheel without having to locate cooling components external to the steering wheel.

### BRIEF DESCRIPTION OF THE DRAWINGS

FIG. 1 illustrates a top view and a cross-sectional view of exemplary channels and ventilation holes in a steering wheel;

FIG. 2 illustrates a top view and a cross-sectional view of exemplary channels and ventilation holes in a steering wheel;

FIG. 3 illustrates a top view and a cross-sectional view of exemplary channels and ventilation holes in a steering wheel;

FIG. 4 illustrates a top view and a cross-sectional view of exemplary channels and ventilation holes in a steering wheel;

FIG. 5 illustrates an example of a heating wire in a layer of the steering wheel;

FIG. 6 illustrates an exemplary steering wheel including a ventilation system;

FIG. 7 illustrates a close-up view of the fans of the ventilation system of FIG. 6;

FIG. 8 illustrates a trim cover over the steering wheel and ventilation system;

FIG. 9A illustrates a thermal image of an exemplary steering wheel including a ventilation system after 30 seconds of use;

FIG. 9B illustrates a thermal image of an exemplary steering wheel including a ventilation system after 5 minutes of use;

FIG. 9C illustrates a thermal image of an exemplary steering wheel including a ventilation system after 10 minutes of use;

FIG. 10A illustrates an exemplary steering wheel including ventilation system including a ventilation bag;

FIG. 10B illustrates a trim cover over the steering wheel and ventilation bag of FIG. 10A;

FIG. 10C illustrates a blower of the ventilation system of FIG. 10A connected to the ventilation bag;

FIG. 10D illustrates the ventilation bag in a free or uninstalled state;

FIG. 11A illustrates a close-up view of an exemplary steering wheel including a ventilation system including a ventilation bag;

FIG. 11B illustrates a heater disposed over the ventilation bag of FIG. 11A;

FIG. 11C illustrates wiring connected to the heater and the ventilation system of FIG. 11B;

FIG. 11D illustrates a trim over extending over the steering wheel and ventilation system of FIG. 11A;

FIG. 12 illustrates a cross-sectional view of one example of a ventilation system including a heater;

FIG. 13A illustrates a perspective view of an example of a blower hood attachment;

FIG. 13B illustrates a bottom view of a blower hood attachment;

FIG. 13C illustrates a top view of a blower hood attachment;

FIG. 13D illustrates a side view of a blower hood attachment;

FIG. 14A illustrates a perspective view of a conditioning system including a connecting device and a thermal electric device for active conditioning;

FIG. 14B illustrates an exploded view of FIG. 14A;

FIG. 15A illustrates a perspective view of a conditioning system for ventilation only including a connecting device;

FIG. 15B illustrates an exploded view of FIG. 15A;

FIG. 16A illustrates a conditioning system configured to be a pull system; and

FIG. 16B illustrates an exploded view of FIG. 16A.

### DETAILED DESCRIPTION

The explanations and illustrations presented herein are intended to acquaint others skilled in the art with the invention, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. The present teachings claim priority to U.S. Provisional Patent Application No. 61/992,515 filed on May 13, 2015 the teachings of which are incorporated by reference herein in its entirety.

The present teachings provide a ventilation system for a steering wheel. The steering wheel may include a movable part and a static part. All of the ventilation system may be located within the movable part. A portion of the ventilation system may be located in the movable part and a portion of the ventilation system may be located in the static part and the two parts may be in fluid communication.

The ventilation system may function to move air across a body part of an occupant so that the temperature experienced by the body part is changed relative to the pre-existing ambient conditions (e.g., below freezing temperature or heat). The ventilation system may function to push, pull, or both air through a distribution system. The ventilation system is entirely located within the steering wheel. A portion of the ventilation system may be located within the steering wheel and a portion of the ventilation system may be located remote from the steering wheel. For example, the distribution system may be located in the steering wheel and the blowers may be located in the steering column. The ventilation system may be free of contact with a vehicle's heating, ventilation, and air conditioning system. The ventilation system when covered by a trim layer is free of read-thru (e.g., the driver or occupant cannot feel the ventilation system through the trim layer). The ventilation system may include a built in trim cover so that a separate trim cover is not needed to cover the ventilation system. Preferably, the steering wheel includes a foam layer having one or a plurality of channels, one or a plurality of ventilation holes or both.

The one or more channels, the one or more ventilation holes, or both may be configured so that no read-thru is experience by the user. The one or more channels, the one or more ventilation holes, or both may function to distribute air from an internal fluid passageway to a user contact location, a location of interest, or both. The channels may extend part of a way through a foam layer or all of the way through a foam layer. The one or more channels may be connected to an internal fluid passageway and extend from the internal fluid passageway to a surface of the foam. The one or more channels may me discrete from one another. The one or more channels may connect together at the internal fluid passageway. The one or more channels may be generally parallel. The one or more channels may extend from the internal fluid passageway at an angle. The one or more channels may stop and start intermittently. For example, if there are three channels, one channel may stop while the other two extend and then another channel may start while the other two extend so that at least two channels are extending at all times. The channels may be free of holes. The channels may be generally “V” shaped, include a “V” shaped portion, generally “W” shaped, include a “W” shaped portion, or a combination thereof when viewed in the cross section. A distribution pipe may extend into the internal fluid passageway so that fluid is distributed out of the channels. The ventilation holes may be through holes that extend all of the way through the foam or continue on past the channels and through the foam. The holes may extend into communication with an internal fluid passageway so that fluid may be moved to a desired location. The ventilation holes may be located in any configuration so that a driver experiences conditioning of the steering wheel. The ventilation holes may be located in a straight line, zig-zag pattern, pairs, wave pattern, offset, staggered, or a combination thereof. More ventilation holes may be concentrated at locations typically contacted by a driver such as at the “ten o'clock” and “two o'clock” positions. The ventilation system may be used with a steering wheel having a hollow rim, a sold rim, or both.

The hollow inner rim of steering wheel may function as an internal fluid passageway. The hollow inner rim may function to form a portion of an internal fluid passageway. The inner rim may direct air to the channels, the holes, or both. The inner rim may have portions that are solid and prevent air from exiting the inner rim and portions that include either holes or passages that allow the air to exit the inner rim to a predetermined location. The inner rim may have passages that align with the channels, the holes, or both. The inner rim may be in direct communication with the foam. The inner rim, the internal fluid passageway, or both may have a portion that extends into the molded foam, the holes, the channels, or a combination thereof. The inner rim may be in fluid communication with one or more blowers.

The one or more and preferably a plurality of blowers may function to move air through the ventilation system. The ventilation system may include a single blower, 2 or more, 3 or more, or even 4 or more blowers that move air throughout the ventilation system. The blowers may be an axial fan, a blower, a radial fan, or a combination thereof. The blowers may move a sufficient amount of air so that the air mover cools the steering wheel in about 10 minutes or less, preferably about 5 minutes or less, or more preferably about 1 minute or less. The blowers may push air, pull air, or both. The blowers may switch between pushing and pulling. The blowers may be located within the steering wheel. When the blowers are located within the steering wheel, preferably the blowers are located outside of the center, outside of a center region, or both. The blowers may be located proximate to the steering wheel. The blowers may be located on the spokes. The blowers may be connected to the steering wheel, the rim, or both. The blowers may be located outside of the steering wheel. The blowers may be located in a steering column. The blowers may be located in a static part. The blowers may be connected to a connecting device. The blowers may move during use or be connected to a part that moves. The blowers may be static during use, or be connected to a part that is static. The ventilation system, blowers, or both may include a thermoelectric device. The ventilation system, the blowers, or both may be free of a thermoelectric device.

The ventilation system may include a distribution system (e.g., a bag or through holes in foam) that distributes the air from the blowers. The distribution system may function to provide air to and/or remove air from a location of interest. The distribution system may evenly distribute air to and/or from a plurality of locations. The distribution system may include one cooling region, preferably two or more cooling regions, more preferably three or more cooling regions, or even more preferably four or more cooling regions. The cooling regions of the distribution system may each cool a length of the steering wheel of about 15 degrees or more, preferably about 30 degrees or more, more preferably about 45 degrees or more, or even more preferably of about 60 degrees or more. Each cooling region may cool a length of about 360 degrees or less, preferably about 180 degrees or less, or even more preferably about 90 degrees or less. The distribution system may include the channels and holes discussed herein. The distribution system may include internal fluid passageways, connect to internal fluid passageways, or both. The distribution system may connect at least in part to a rim, a foam layer, spokes, or a combination thereof. The distribution system may include a bag that is open on one or more sides, sealed on all sides, be air impermeable, have one or more air impermeable edges, or a combination thereof. The bag may mirror the shape of the steering wheel and spokes. The bag may include one or more straight body portions. The bag may include one or more legs. The one or more legs may extend from the straight body portions. The one or more legs may mirror the shape of the spokes. The one or more legs, body portions, or both may include reliefs. The one or more reliefs may accommodate a spoke, a rim, foam, or a combination thereof. The one or more reliefs may allow the bag and spacer to extend around a circumference of a steering wheel. The one or more reliefs may be an absence of spacer. The one or more reliefs may be a thinner portion of spacer material. The ventilation system may be free of a bag. The bag may be a polymeric material that is air impermeable. The polymeric material may include perforations or holes that allow air to exit the bag at predetermined locations. The region of the polymeric material may create an internal fluid passageway so that fluid can pass from an air mover to the region of the polymeric material with holes. A spacer material may be located within the polymeric material that allows air to move within the polymeric material (e.g., bag). The spacer material may function to create an open space within the bag. The spacer material may be a Mueller spacer. The bag, the spacer material, or both may substantially mirror the shape of the steering wheel, the spokes, or both. The bag, the spacer material, or both may extend around about 360 degrees or less of the steering wheel, about 270 degrees or less, about 180 degrees or less, or even about 90 degrees or less, when viewing a cross section of the steering wheel. The bag may extend along a portion of the steering wheel and then wrap around a contact region of the steering wheel in order to provide a distribution region that extends about 180 degrees or more, about 270 degrees or more, or even about 360 degrees around the steering wheel. The bag may be connected to the steering wheel with a mechanical fastener or an adhesive. For example, a hook and loop fastener or a peel and stick adhesive may connect the bag within the steering wheel. The distribution system may be comprised of one or more channels that extend through one or more layers in the steering wheel. The distribution system may be connected to a blower hood, a blower hood attachment, or both (hereinafter a blower hood).

The blower hood may function to connect a blower to a distribution system either directly or indirectly. The blower hood may function to allow air to be pushed, pulled, or both between the blower and the distribution system. The blower hood may attach to an air inlet, air outlet, or both of a blower. The blower hood may directly connect to the distribution system. The blower hood may indirectly connect to the distribution system. The blower hood may connect to a distribution pipe that extends from the blower hood to the distribution system. The distribution pipe may extend into the foam, into the bag, or both. The distribution pipe may connect to the foam, the bag, or both by a connector. The connector may extend into an internal fluid passageway. The connector may form a friction fit, an interference fit, or both within the internal fluid passageway. The connector may be “T” shaped. The connector may be an integral part of the distribution pipe. The connector may be a separate from the distribution pipe. The connector may form an interference fit, a snap fit, a friction fit, or a combination thereof with the distribution pipe. The connector may connect to an inlet or an outlet of the blower hood. The blower hood may have an inlet and an outlet. The blower hood may connect directly to a bag, a polymeric layer, or both. The blower hood may extend into the bag, around a portion of the bag, into communication with a spacer, or a combination thereof. The distribution system may include a heater, be connected to a heater, be in communication with a heater, or a combination thereof.

The heater may function to provide heat to the steering wheel. The heater may function to resistively heat. The heater may function to provide heat to an air stream. The heater may be a conductive heater, a convective heater, or both. The heater may be part of a thermal electric device (e.g., Peltier device). Preferably, the heater is a resistive heater such as a lay wire heater, a positive temperature coefficient heater, carbotex, a conductive felt material, a heating wire, silver, a conductive woven material, a conductive non-woven material, a permeable woven or non-woven material or a combination thereof. The heater may be connected within the ventilation system using a mechanical fastener and preferably an adhesive such as a peel and stick adhesive or a pressure sensitive adhesive. Some examples of heaters that may be used with the present teaches are found in U.S. Pat. Nos. 6,838,647; 7,145,102; 7,714,258; 7,838,804; and 8,702,164 the teachings of which are expressly incorporated by reference herein in their entirety for all purposes.

The one or more connecting devices may function to fluidly connect a stationary part (e.g., a steering wheel column) to a movable part (e.g., a steering wheel). The one or more connecting devices may function to allow a fluid to move from a stationary component of the connecting device through a movable component of the connecting device while preventing fluid conduits form bending, kinking, breaking, being rotated, being stretched, or a combination thereof. The one or more connecting devices may function to allow the one or more fluid conduits and preferably a plurality of fluid conduits to remain static relative to the movable component while the movable component rotates and/or moves. The connecting devices may function to allow relative movement of some of the fluid conduits relative to a stationary component while holding the fluid conduits static relative to the movable component. The connecting device may have a fluid channel that extends therethrough and connects fluid conduits on the static component with fluid conduits on the movable component. The connecting device may allow fluid to pass between a static component and a movable component without any air guidance devices (e.g., lines) extending between the movable part directly to the static part. The connecting device may have one or more chambers that receive fluid (i.e., connector channels). The connecting device may have one or more fluid paths so that fluid extends from a static component to a movable component. The connecting device may have one open space. The channels, open space, or both may include one or more heat exchangers, one or more thermal electric devices, one or more Peltier devices, or a combination thereof. The connecting device may provide one or more sealed chambers that allow fluid to pass into contact with the conducting elements without the fluid conduits being directly subjected to movement of the movable component. The one or more connecting devices may decouple the fluid conduits from the movable parts so that the movable parts can move without interfering with the fluid conduits to move fluid to a location of interest. The one or more connecting devices may include a movable component, a static component, or both that form a chamber for fluidly connecting a movable part with a fluid transport device.

The one or more movable components may function to move with a movable part. The one or more movable components may function to move relative to a static part, a static component, or both. The one or more movable components may function to form a static connection with one or more conducting elements located in the movable component. The one or more movable components may allow for rotational movement, longitudinal movement, lateral movement, or a combination thereof without loss of fluid movement. The one or more movable components may have one or more surfaces that contact a static part, contact one or more bearings, contact one or more seals, form a bearing surface, or a combination thereof. The one or more movable components may form a seal with a static part, be sealed by a static part, or a combination of both. The one or more movable components may form one or more surfaces that enclose a chamber and/or channel (e.g., supply channels, through channels, and/or connector channels as discussed herein). The one or more movable components may be generally cylindrical, square, rectangular, round, circular, toroidally shaped, or a combination thereof. The one or more movable components may longitudinally slide along a static components and one or more channels may extend between the static components and movable components. The one or more channels may be in a central location of the static components and the movable components may move so that the movable component is always in fluid communication with the one or more channels. The one or more movable components may extend fully or partially around an outside of a static component. The one or more movable components may create all or a portion of a channel (e.g., a supply channel, a collector channel, a connector channel, or a combination thereof). The one or more movable components may extend into a static component. The one or more movable components may receive a portion of a static component to form a seal. The one or more movable components and static components may be separated by one or more seals (e.g., a gasket, a rubber piece, an “O” ring, or a combination thereof). The one or more movable components may include one or more air inlets, one or more air outlets, or both. The one or more movable components may include 2 or more, 3 or more, 4 or more air inlets. The one or more movable components may include 2 or more, 3 or more, or 4 or more air outlets. The one or more movable components may include a plurality of air inlets, a plurality of air outlets, or both. The air inlets, the air outlets, or both may be connected to one or more and preferably two or more fluid conduits. The air inlets, the air outlets, or both may be in communication with a supply channel in the connecting device. The supply channel may be in fluid communication between the movable components and the static components. The supply channel may extend substantially the entire length of the movable component, the static component, or both. The one or more movable components may extend around one or more static components or vice versa.

The one or more static components may function to connect to a steering rod and/or steering device and permit for movement of the steering rod and/or steering device relative to a static part. The one or more static components may function to connect to a stationary part (e.g., a static part) and provide a base for the movable component. The one or more static components (e.g., a stationary component) may function to connect to one or more conducting elements, one or more fluid transfer devices, or both extending from the static component, the movable component, or both. The one or more static components may include a shaft aperture to connect to a shaft of a steering device. For example, the shaft aperture may be a hole in the connecting device that the steering wheel rod, steering wheel pivot axis, or both extend through. The one or more static components may function to create a portion of a supply channel, connector channel, or both. The one or more static components may create a longitudinal channel, a lateral channel, a radial channel, or a combination thereof. The static components may include one or more channels (e.g., a supply channel and a collector channel). The static part may be connected to a static component and a movable component and/or may move about the static part. The static components may have a movable component that moves within the static components. The static components may form a fixed connection with one or more conducting elements. The static components may connect with or be in communication with fluid conduits. The static components may have one concentric channel or a series of concentric channels. The static components may have channels that are circular, generally “L” shaped, square, rectangular, or a combination thereof. The static components may have channels that extend parallel to an axis of a movable component. The static components may have channels that extend outward around an axis of the movable component. The one or more static components may have one or more through channels that extend from a first side of the static components to the second side of the static components. For example, the static components may include a through channel that extend from a first half through a divider to a second half. The static components and movable components may be separated by one or more seals, one or more bearings, one or more gaskets, one or more “O” rings, or a combination thereof. The static components and movable components may be connected together to form a supply portion, a receiver portion, or both.

The one or more supply channels may function to provide air from a fluid transfer device through the connecting device. The one or more supply channels may be a fluid path through a connecting device. The one or more supply channels may be free of any lines, tubes, hoses, or a combination thereof. The one or more supply channels may replace a line, tube, hose, fluid conduits, or a combination thereof. The one or more supply channels may extend towards the occupant contact areas from a fluid transport device. The one or more supply channels may include conducting elements that extend from the movable part into the connecting device. The one or more supply channels may have a portion that is fully enclosed within the static component, the movable component, or both. The one or more supply channels may have a portion that is formed between the static component, the movable component, or both. The one or more supply channels may have a portion that is formed between the static component and the movable component, a portion that is fully formed in the static component, a portion that is fully formed within the movable component, or a combination thereof. The one or more supply channels may house one or more thermal electric devices, one or more heat exchangers, a portion of the one or more fluid conduits, or a combination thereof. The connecting device may include one or a plurality of supply channels that are connected to an inlet, an outlet, or both.

The one or more air outlets may function to remove air from the connecting device, allow air to exit the connecting device, or both so that thermal energy is removed. The one or more air outlets may direct waste air away from the conducting elements, thermal electric devices, heat exchangers, or a combination thereof. The one or more air outlets may be located in the static component, the movable component, or both. The one or more air outlets may be located in the static component and moved relative to the movable component or vice versa. The one or more air outlets may move air away from the connecting device, may receive air into the connecting device, or both. The one or more air outlets may provide air from the connecting device to a thermal electric device, heat exchanger, conducting element, peltier device, or a combination thereof. The one or more air outlets may provide air from the connecting device to a waste area, an air mover, or both. The one or more air outlets may be located proximate to an air inlet, a fluid conduit, or both. The one or more air outlets may be connected to an air mover so that air is pulled out of the connecting device through the fluid conduit. The one or more air outlets may lead into the conduit. The one or more air outlets may be used to push air through the conditioning system or pull air through the conditioning system. The one or more air outlets may extend directly into ambient, into a static part, a movable part, or a combination thereof. The one or more air outlets and air inlets may be located a sufficient distance apart so that waste air is not pulled into the fluid transport device and recirculated through the connecting device.

The one or more air inlets may function to provide air into the connecting device. The one or more air inlets may function to provide ambient air into the connecting device to remove waste thermal energy (e.g., heat or cool from a heat exchanger). The one or more air inlets may be located on a discharge side of a fluid transport device (e.g., blower). The one or more air inlets may be located on a connecting device proximate to the movable part and air may be pulled into the connecting device by the fluid transport device pulling air into the connecting device. The one or more air inlets may be located proximate to a thermal electric device, a heat exchanger, an end of a conducting element, or a combination thereof.

The ventilation system of the teachings herein may change the temperature of the steering wheel by about 10° C. or more, about 20° C. or more, or even about 25° C. or more. The ventilation system may change the temperature by about or more per minute, about 1.5° C. or more per minute, or even about 2° C. or more per minute. The ventilation system may be formed using a method.

The method may be performed in virtually any order. A distribution system may be connected to a steering wheel, spokes, or both. One or more channels may be formed in a foam layer. An internal fluid passageway may be formed in the foam. A foam layer be connected to a rim, a hollow rim, or both. A bag may be connected to a steering wheel, spokes, or both. The distribution system may be connected to one or more blowers and preferably a plurality of blowers. The blowers may be connected to a hood, a blower hood attachment, or both. The blowers may be connected at the inlet, the outlet, or both. The blower hood, the blower hood attachment, or both may be connected to a distribution pipe, a fluid conduit, or both. The blower, the distribution pipe, the fluid conduit, or both may be connected to a connector, a connecting device, or both. The connecting device may be disposed in a static part. The connecting device may be in fluid communication with a movable part. A heater may be disposed over the distribution system, under the distribution system, or both. A thermal electric device, heat exchanger, or both may be disposed within the connecting device. One or more fluid conduits may be connected to an inlet, an outlet, or both of the connecting device. One or more polymeric layers may be sealed together. A spacer may be at least partially sealed within one or more polymeric layers. A trim cover may be placed over the heater, the ventilation system, a portion of the ventilation system, the steering wheel, a heater, or a combination thereof. The distribution system may be wrapped around a circumference of the steering wheel, a length of the steering wheel, or both. Holes may be molded, cut, or both into the channels, the foam layer, or both. Channels may be molded into the foam, cut into the foam, or both.

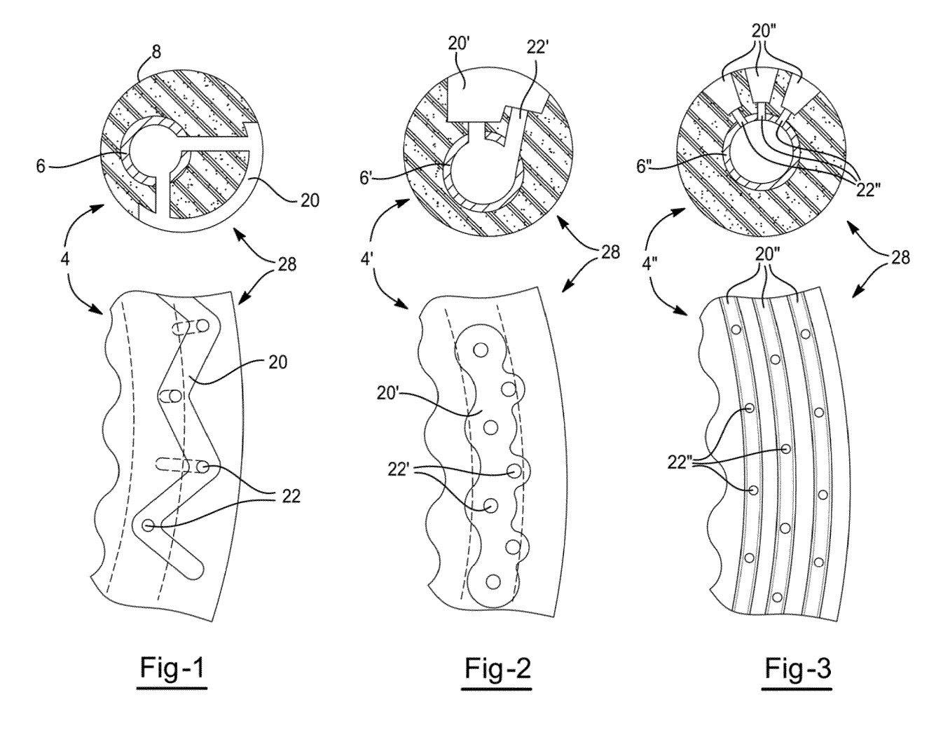

FIG. 1 illustrates a section view and a cross-sectional view of a steering wheel 4. The steering wheel 4 includes a hollow inner rim 6, molded foam 8 disposed on the rim 6, and a perforated trim cover (not shown) covering the molded foam 8 and the rim 6. The steering wheel 4 further includes a serpentine shaped channel 20 and a plurality of ventilation holes 22 extending in the foam 8. Together, the inner rim 8, the channel 20, and the ventilation holes 22 form an air distribution system 28 that pushes or draws air through the trim cover provide heating or cooling to hands of a driver or occupant. In various implementations, the inner rim 8, the channel 20, and the ventilation holes 22 form separate circuits for pushing air out through the trim cover and for pulling air in through the trim cover.

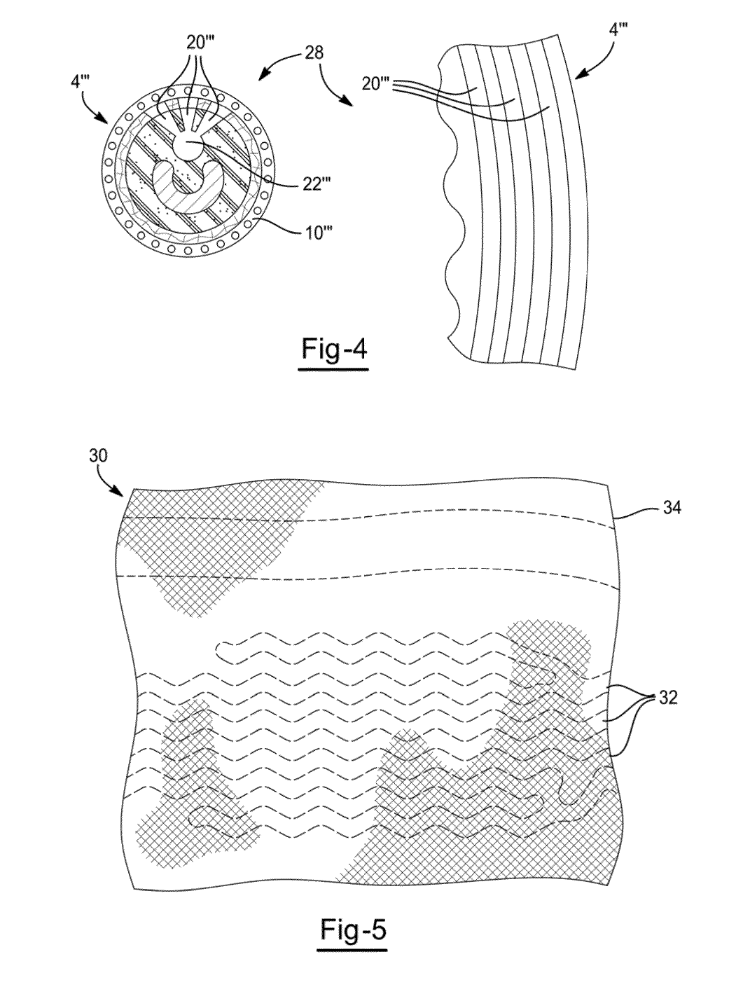

FIG. 2 illustrates a section view and a cross-sectional view of another example of a steering wheel 4′ with an air distribution system 28. The steering wheel 4′ is substantially similar to the steering wheel 4, except the steering wheel 4′ has molded foam 8′ that includes a zig-zag shaped channel 20′ with alternating ventilation holes 22′.

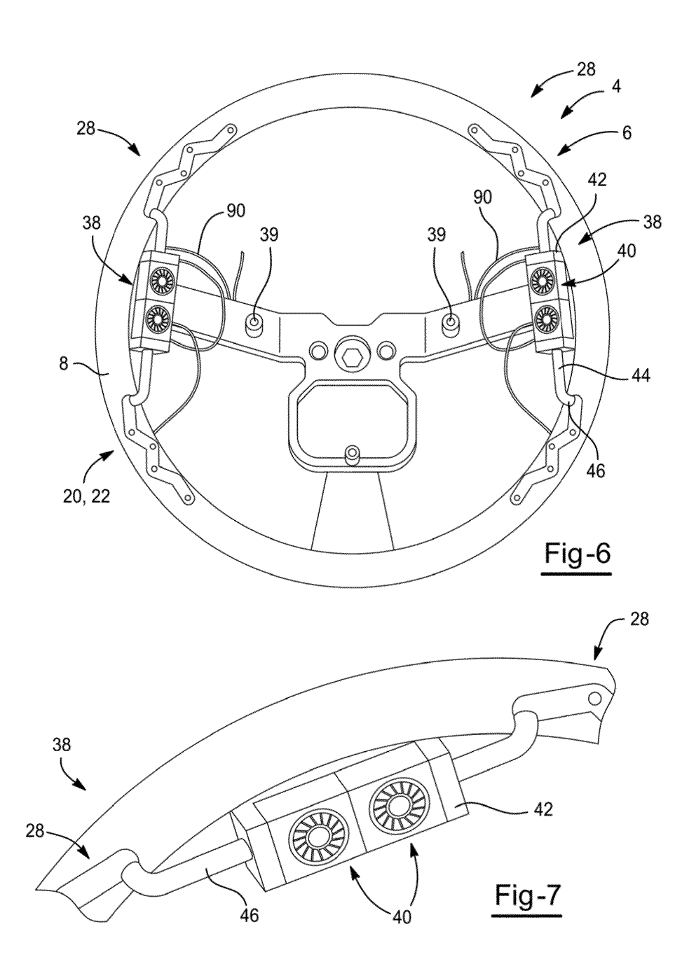

FIG. 3 illustrates a section view and a cross-sectional view of another example of a steering wheel 4″ with an air distribution system 28. The steering wheel 4″ is substantially similar to the steering wheel 4, except the steering wheel 4″ includes molded foam that includes a plurality of generally straight channels 20″ with alternating ventilation holes 22″.

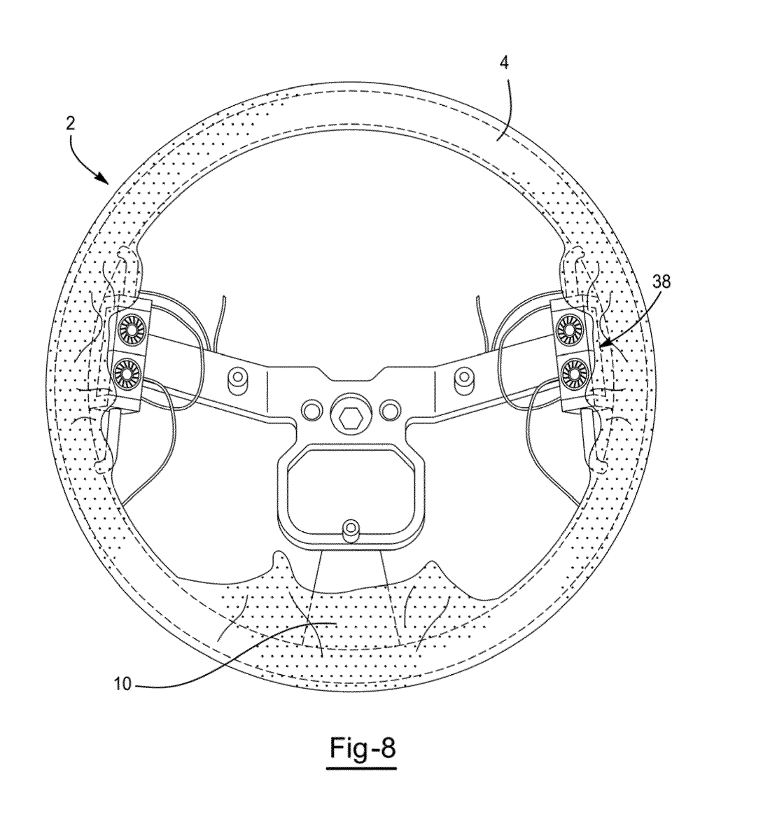

FIG. 4 illustrates a section view and a cross-sectional view of another example of a steering wheel 4′″ with an air distribution system 28. The steering wheel 4′″ includes a solid inner rim 6′″, molded foam 8′″ disposed on the rim 6′″, and a perforated trim cover 10′″. The foam 8′″ includes a plurality of generally straight channels 20′″ extending from a plenum 22′″. Together the channels 20′″ and the plenum 22′″ form an air distribution network.

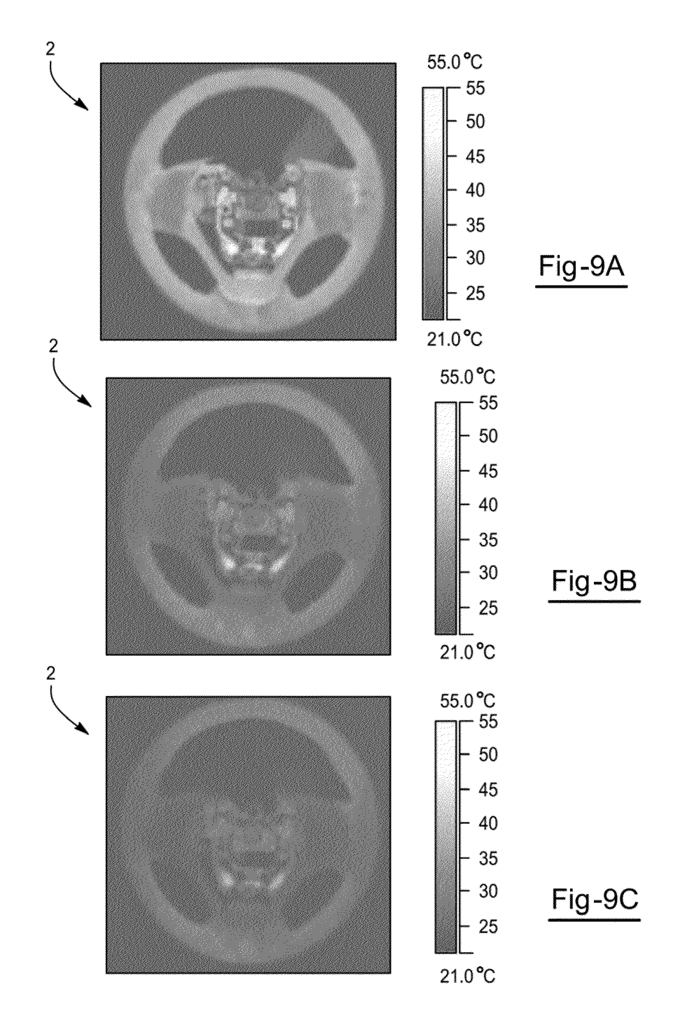

FIG. 5 illustrates a heater 30 including a heating wire 32 disposed on and sewn into a flexible heater substrate 34 which can be disposed on an wrapped around the molded foam (e.g. molded foam 8) beneath the trim cover (e.g. trim cover 10′″).

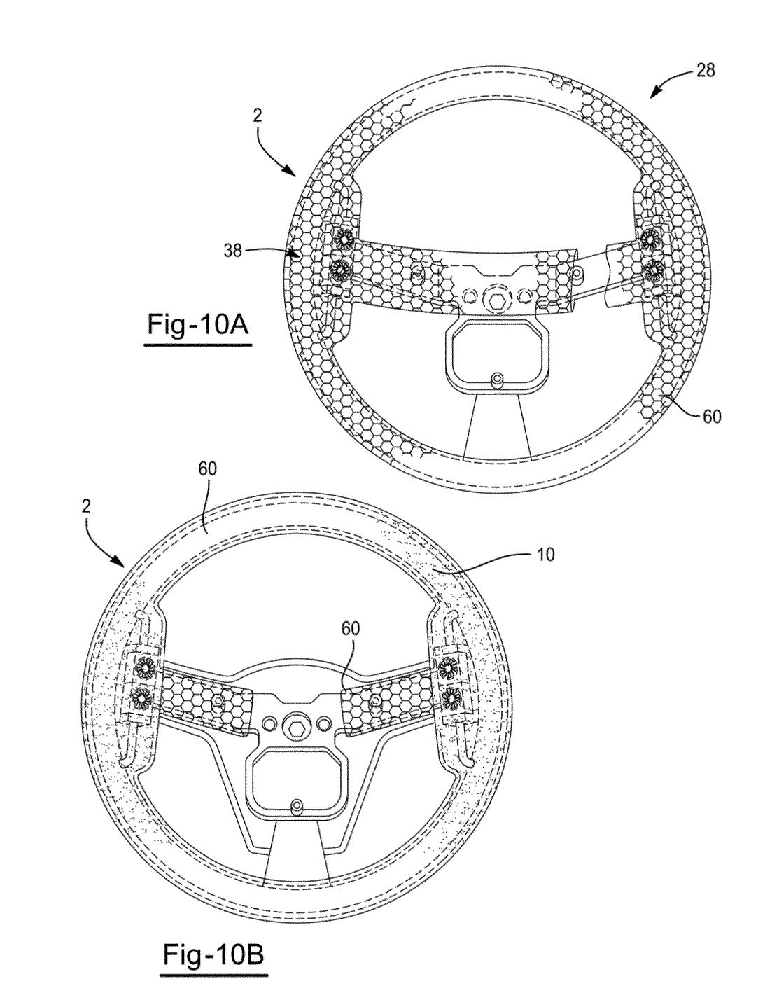

FIG. 6 illustrates a f ventilation system 38 on opposing sides of a steering wheel 4 with the ventilation system 38 being connected to an air distribution system 28 having channels 20 and ventilation holes 22 that extend through molded foam 8 of the steering wheel 4. For exemplary purposes, the ventilation system 38 will be described with reference to the steering wheel 4. The ventilation systems 38 are each attached to the rim 6 via spokes 39 of the steering wheel 4. The ventilation systems 38 each include a pair of blowers 40 that are connected to a blower hood 42 that guides air into a distribution pipe 44. The blowers 40 are powered by wires 90 that extend along the spokes 39 of the steering wheel 4. The distribution pipe 44 connects to a plenum in the rim 6 of the steering wheel 4 by a connector 46 so that air from the blowers 40 is guided through the rim 6, the channels 20, and the ventilation holes 22 to or from the trim cover.

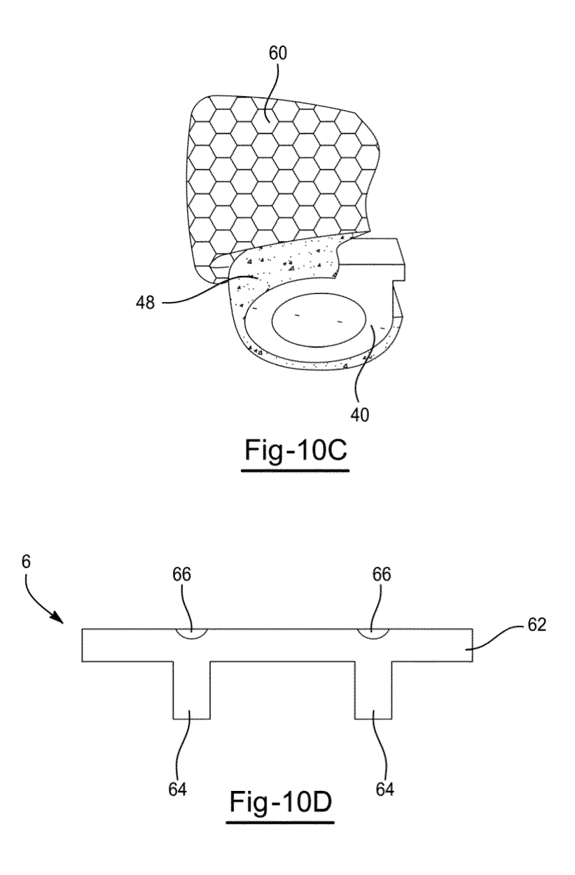

FIG. 7 illustrates a close up view of the ventilation system 38 illustrating the pair of blowers 40 connected to the blower hood 42 and the connector 46 so that air is guided towards or away from hands of a driver or occupant via an air distribution system 28.

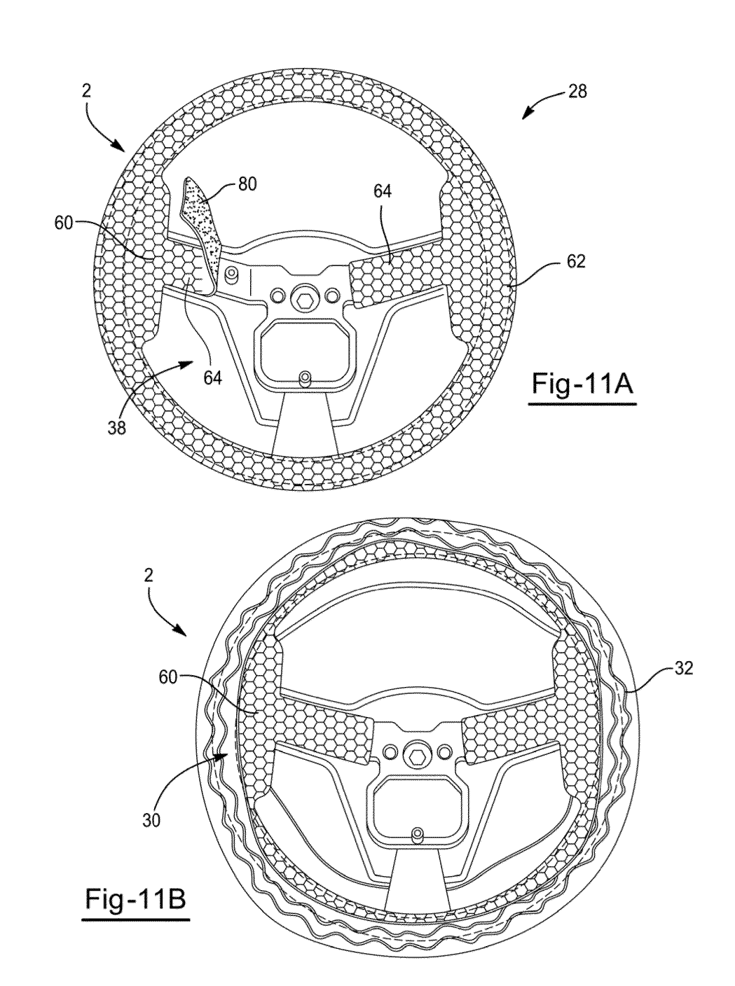

FIG. 8 illustrates an exemplary perforated leather trim cover 10 for the steering wheel 4. The trim cover 10 is disposed on and wraps around the foam 8 and covers the ventilation system 38.

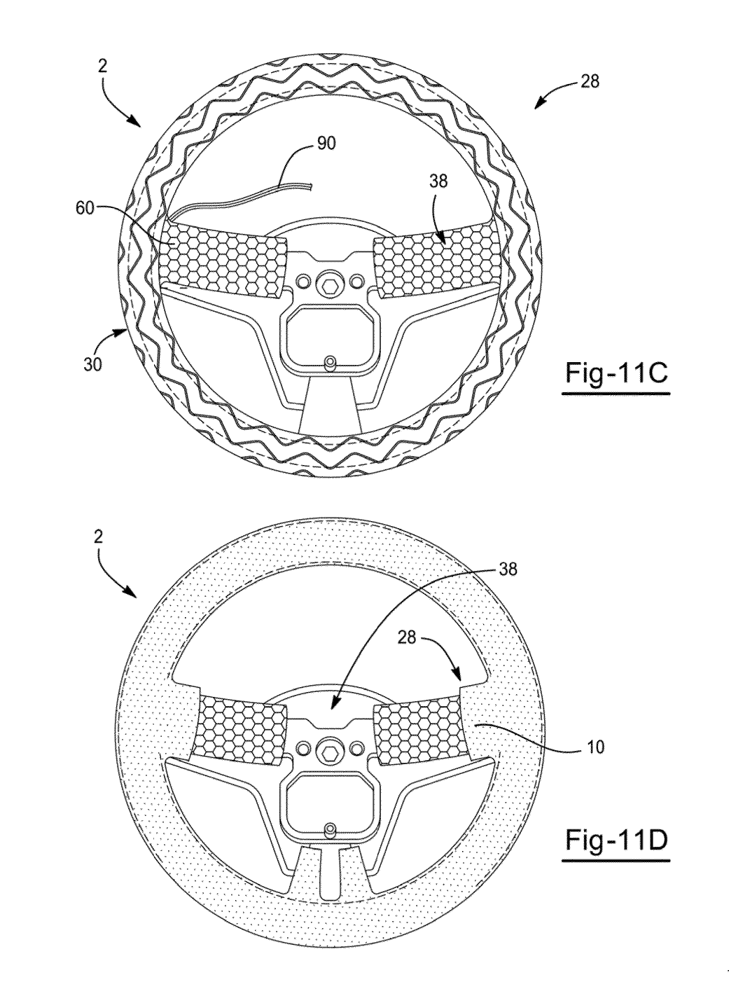

FIG. 9A is a thermal image of a steering wheel after the ventilation system has been on in push mode for 30 seconds.

FIG. 9B illustrates a thermal image of a steering wheel after the ventilation system has been on in push mode for 5 minutes.

FIG. 9C illustrates a thermal image of a steering wheel after the ventilation system has been on in push mode for 5 minutes. Although FIGS. 9A-9C depict a steering wheel in push mode, thermal images of a steering wheel including a ventilation system in pull mode look substantially similar.

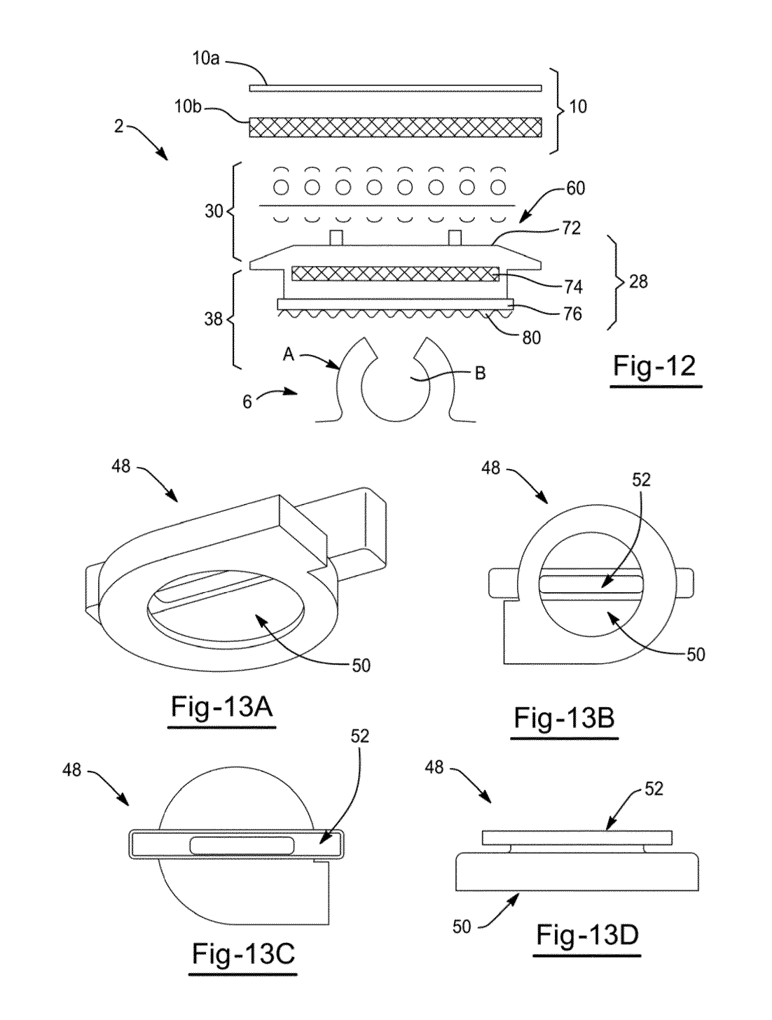

FIGS. 10A-D illustrate a steering wheel 2 including a ventilation system 38 and a distribution system 28. The distribution system 28 as shown is in the form of an enclosure or bag 60. The bag 60 is configured to connect to a pair of fans or blowers as partially shown in FIG. 10C.

FIG. 10B illustrates a trim cover 10 that covers the bag 60.

FIG. 10C illustrates a close-up view of a blower 40 connected to a blower hood 42. The blower hood 42 connects the blower 40 to the bag 60 so that the bag 60 distributes the air from the blower 40.

FIG. 10D illustrates an exemplary construction and shape of the bag 60. The bag 60 includes a generally straight body 62, a pair of legs 64, and optionally reliefs 66. The body is configured to wrap around a rim (e.g. rim 6) of the steering wheel. The legs 64 are configured to extend along spokes (e.g. spokes 39) of the steering wheel 2 between the rim and locations where the fans or blowers attach. The reliefs 66 may accommodate the spokes to allow the body 62 to wrap fully around the rim. In various implementations, the body 62 and the legs 64 can be configured such that ends of the body 62 adjoin at a predetermined location of the steering wheel where hands of the driver are unlikely to contact, for example at a six o'clock location.

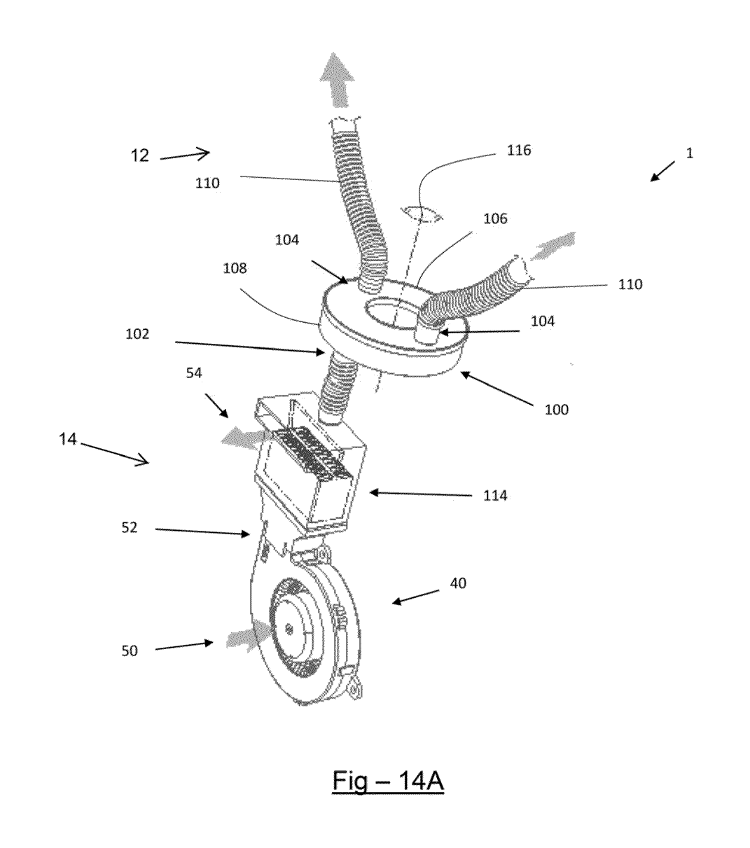

FIGS. 11A-C illustrate an exemplary construction and method of assembling the ventilation system 38 and distribution system 28 to the steering wheel 2. FIG. 11A illustrates a step of assembling the bag 60 of the distribution system 28 to the rim of the steering wheel 2, which can include aligning the legs 64 with the spokes and wrapping the body 62 around the rim. In various implementations, adhesive (e.g. adhesive 80) on one side of the bag 60 can adhere the bag 60 to the rim.

FIG. 11B illustrate steps of assembling a heater 30 to cover the bag 60. The heater 30 includes a heating wire 32 that heats the steering wheel 2. The heater 30 can be perforated to allow air to pass through. In this way the heater 30 can provide heat via conduction and convection.

FIG. 11C illustrates the heater 30 fully covering the steering wheel 2 and the bag 60 of the ventilation system 38. A plurality of wires 90 are connected to the ventilation system 38 so that when power is supplied the ventilation system 38 moves air for cooling (and optionally heating when used in combination with the heater 30) the steering wheel 2 and hands of a driver (not shown) through the distribution system 28.

FIG. 11D illustrates a step of assembling the trim cover 10 extending over both the ventilation system 38 and the distribution system 28 and the rim and portions of the spokes of steering wheel 2.

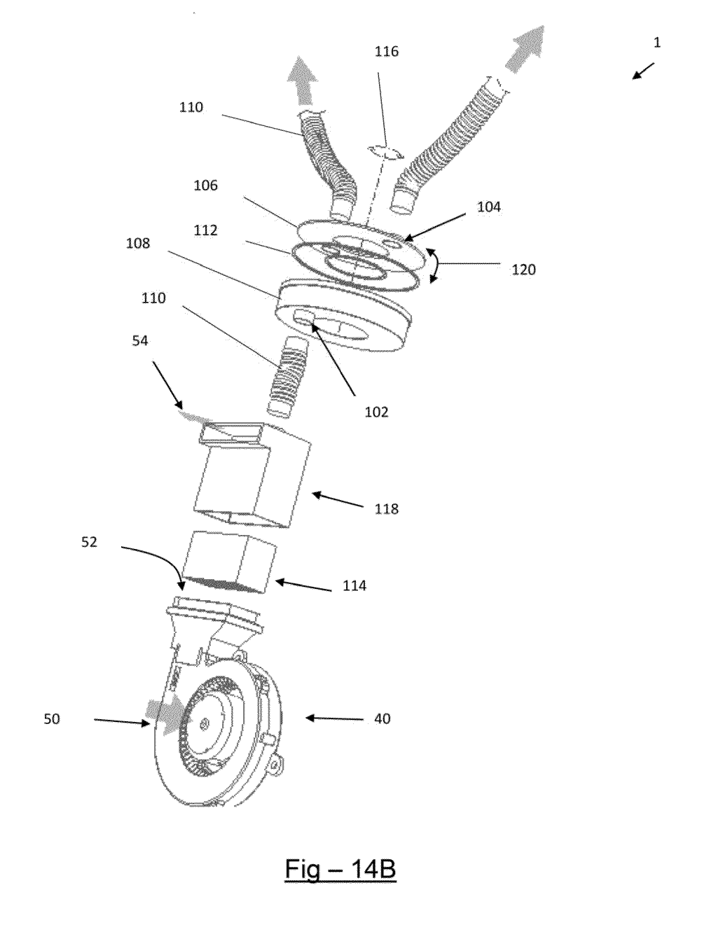

FIG. 12 schematically illustrates a cross sectional view of an exemplary layering or stack-up of the steering wheel 2, including the heater 30 and the ventilation system 38. As illustrated, the stack-up includes the rim 6, the ventilation system 38, the heater 30, and the trim cover 10 in that order. As illustrated, the trim cover 10 can include an outer leather cover 10a and a foam layer 10b. The trim cover 10 is over the foam layer 10b with the heater 30 located under the foam layer 10b. The heater 30 is located over the ventilation system 38, which includes the distribution system 28 and bag 60. The bag 60 includes an upper layer 72 connected to a bottom layer 76 and enclosing a spacer 74 therebetween. The bag 60 is sealed at the edges to form air impermeable edges. The bag 60 is wrapped around and connected to the inner rim 6 having a center opening B of a steering wheel 2 by an adhesive 80 as indicated by arrows A.

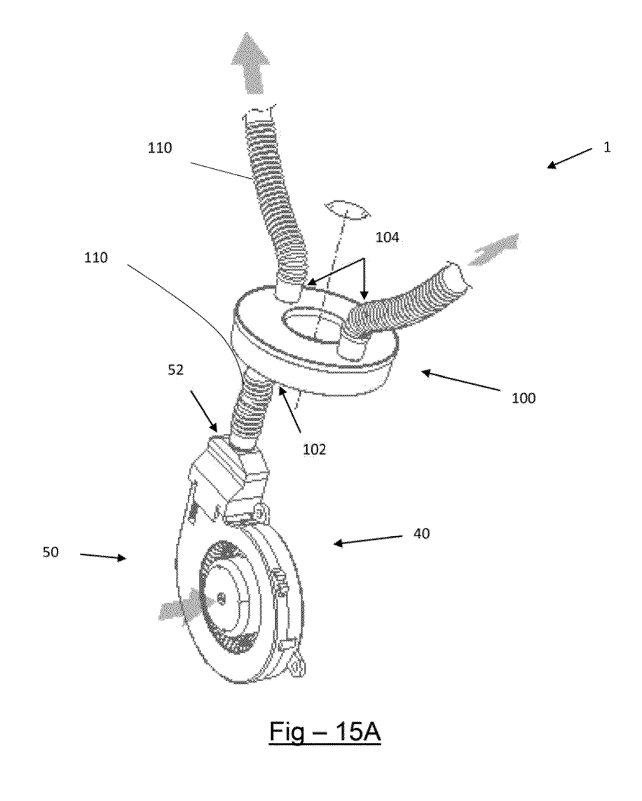

FIGS. 13A-D are views illustrating an example of a blower hood attachment 48. FIG. 13A is a perspective view illustrating the blower hood attachment 48 includes an opening or inlet/outlet 50 that connects to an inlet (e.g. for pull operation) or outlet (e.g. for push operation) of a blower (not shown).

FIG. 13B is a bottom view illustrating the blower hood attachment 48 includes the inlet/outlet 50 and an inlet/outlet 52 that is located within an end of and connects to one of the legs 64 of the bag 60.

FIG. 13C is a top view illustrating the blower hood attachment 48 and the inlet/outlet 52 in further detail.

FIG. 13D is a side view illustrating the blower hood attachment 48 and the inlet/outlet 50 and the inlet/outlet 52 in further detail.

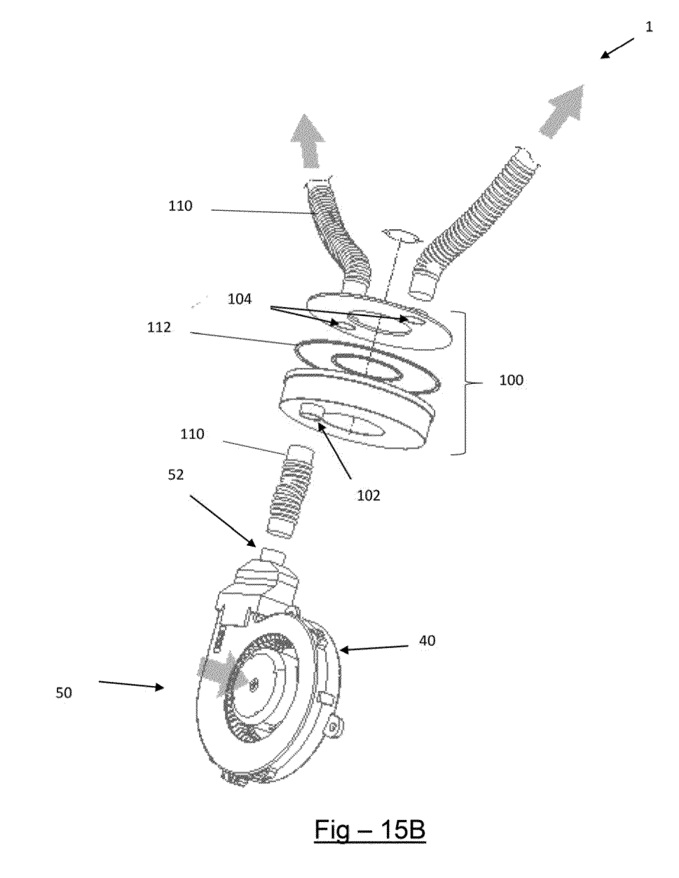

FIG. 14A illustrates a perspective view of a conditioning system 1 in push mode and including an active system, and FIG. 14B illustrates an exploded view of the conditioning system 1. The conditioning system 1 includes a blower 40 that includes an inlet 50 for pulling air in and an output 52 for pushing the air into a conduit 118 that includes a thermal electric device 114. The thermal electric device 114 can be used to produce hot air or cool air that is moved through the conditioning system 1 and the unwanted waste air (either hot or cold) is removed from the system through the waste airport 54. The conduit 118 is connected to an inlet 102 of the connecting device 100 by a fluid conduit 110 that extends therebetween. The connecting device includes a movable component 106, a static component 108 and a seal 112 therebetween. The movable component 106 may be moved in the direction 120 as a movable part (not shown) such as a steering wheel is moved by a user around the axis of rotation 116. The movable component 106 is movable independent of the static component 108. The movable component 106 includes a pair of outlets 104 that are connected to fluid conduits 110 that feed air into the distribution system (not shown) The conditioning system 1 includes a portion within the movable part 12 (and a portion within a static part 14 (the housing of the static part is not shown).

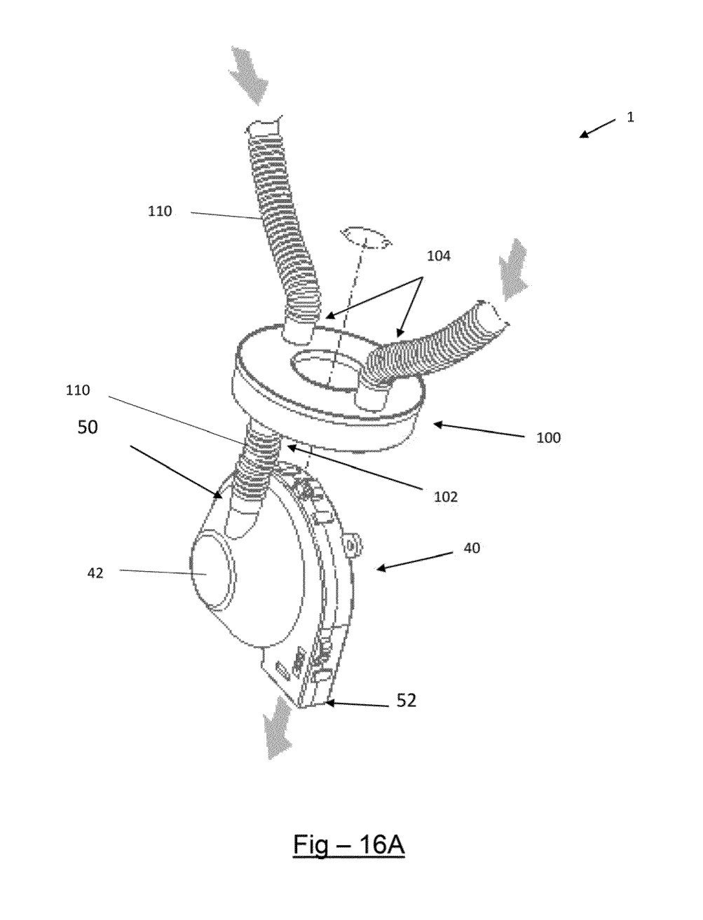

FIG. 15A illustrates a perspective view of a conditioning system 1 in push mode, and FIG. 15B illustrates an exploded view of the conditioning system 1. The conditioning system 1 includes a blower 40 with an inlet 50. The blower 40 has an outlet 52 that is directly connected to a fluid conduit 110. The fluid conduit 110 is connected to an inlet 102 of a connecting device 100. The connecting device includes a seal 112 that substantially maintains fluids within the connecting device 100 so that a majority of the air that enters in the inlet 102 exits from the connecting device 100 via the outlets 104 into the fluid conduits 110 and into a distribution system (not shown).

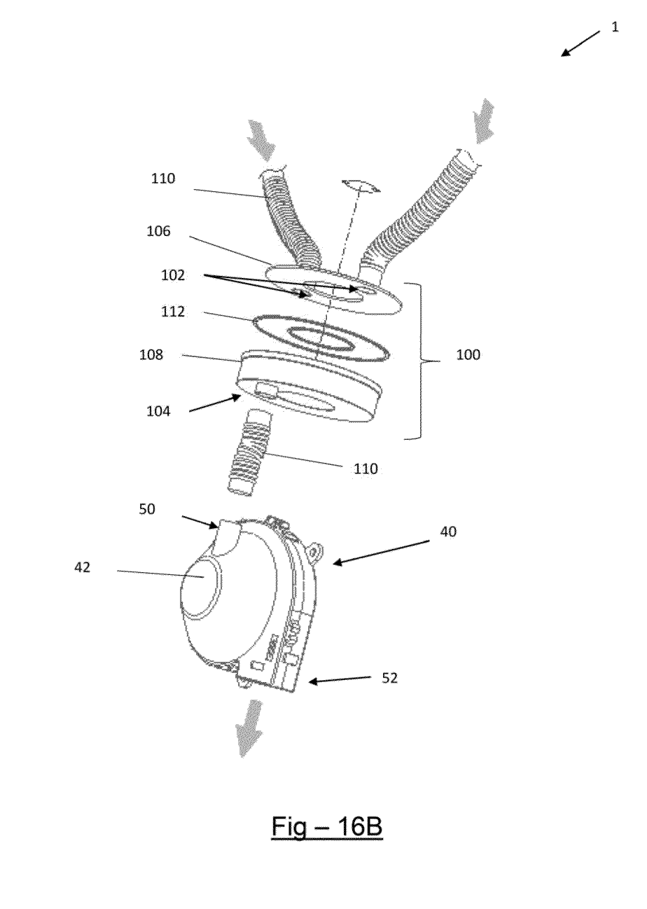

FIG. 16A illustrates a perspective view of a conditioning system 1 in pull mode, and FIG. 16B illustrates an exploded view of the conditioning system 1. The blower 40 includes a blower hood 42 that covers the inlet of the blower (not shown) so that air is pulled into the blower through the inlet 50 and out of the air mover via the outlet 52. The blower hood 42 seals the inlet of the blower 40 so that substantially all of the air supplied to the conditioning system 1 is removed from the distribution system (not shown). The blower 40 inlet 50 is connected to a connecting device 100 by a fluid conduit 110. The fluid conduit 110 extends from the blower inlet 50 to the connecting device outlet 104. The connecting device 100 includes a static component 108 (including the outlet 104) a movable device 106 (including inlets 102) and a seal 112 between the movable component 106 and the static component 108. The inlets 102 of the connecting device 100 are connected to fluid conduits 110.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1 Conditioning System

2 Steering Wheel

4, 4′, 4″, 4′″ Steering Wheel

6 Hollow inner rim

8, 8′ Molded foam

10 Trim Cover

12 Movable Part

14 Static Part

20, 20′, 20″, 20′″ Serpentine shaped channel

22, 22′, 22″, 22′″ Ventilation holes

28 Distribution System

30 Heater

32 Heating Wire

34 Flexible heater substrate

38 Ventilation systems

39 Spokes

40 Blowers

42 Blower Hood

44 Distribution Pipe

46 Connector

48 Blower hood attachment

50 Opening or inlet/outlet

52 Second inlet outlet

54 Waste Air

60 Bag

62 Straight body

64 Pair of legs

66 Reliefs

72 Upper Layer

74 Spacer

76 Bottom Layer

90 Wires

100 Connecting Device

102 Inlet

104 Outlet

106 Movable component

108 Static Component

110 Fluid Conduit

112 Seal

114 Thermal Electric Device

116 Axis of Rotation of Steering eel

118 Conduit

120 Direction of Rotation

We claim:

1) A conditioned steering wheel comprising:
a. a heater and
b. a ventilation system including:
i. a distribution system and
ii. one or more blowers in communication with the distribution system;
iii. a blower hood, blower hood attachment, or both connected to and extending between one or more of the one or more blowers and the distribution system, so that air is moved between the distribution system and the one or more blowers;
wherein the steering wheel has a center and the one or ore blowers are located outside of the center of the steering wheel.

2) The conditioned steering wheel of claim 1, wherein a permeable trim cover extends over and covers the heater, the distribution system, and at least a portion of the ventilation system.

3) The conditioned steering wheel of claim 1, wherein the distribution system includes a foam layer that extends under the trim cover and the heater.

4) The conditioned steering wheel of claim 3, wherein the foam layer includes a plurality of discrete channels that are located around a circumference of the steering wheel.

5) The conditioned steering wheel of claim 4, wherein the foam layer includes a plurality of ventilation holes located within each of the plurality of discrete channels that allow air to extend out of the steering wheel.

6) The conditioned steering wheel of claim 5, wherein the plurality of ventilation holes are staggered, in a straight line, alternating, have a “V” shape, or a combination thereof.

7) The conditioned steering wheel of claim 1, wherein the distribution system is a bag that is a sealed along one or more edges.

8) The conditioned steering wheel of claim 1, wherein the bag includes a single layer that encloses a spacer and creates an open space within the bag.

9) The conditioned steering wheel of claim 1, wherein the heater includes a heating wire, silver, positive temperature coefficient material, a conductive woven material, a conductive non-woven material, a permeable woven or non-woven material, or a combination thereof.

10) The conditioned steering wheel of claim 1, wherein the blower hood includes one or more air inlets and one or more air outlets and the air outlets connect the blower to the air distribution system.

11) The conditioned steering wheel of claim 1, wherein the blower hood is connected to a distribution pipe and the distribution pipe is connected to a connector that connects the distribution pipe to one or more channels is a foam layer of the steering wheel so that air is distributed by the channels.

12) The conditioned steering wheel of claim 4, wherein each of the plurality of blowers, each of the plurality of channels, or both cool a region of the steering wheel that is between about 90 degrees and about 45 degrees of a circumference of the steering wheel.

13) A method comprising:
a. connecting at least a portion of a ventilation system to a steering wheel;
b. connecting a distribution system to a rim, spokes, or both of the steering wheel;
c. connecting a plurality of blowers each to a blower hood, a blower hood attachment, or both so that air from the blower is moved through the ventilation system and the distribution system to a location of interest; and
d. wrapping a heater around at least a portion of the ventilation system, the distribution system, the rim, or a combination thereof;
wherein the steering wheel has a center and the one or more blowers are located outside of the center of the steering wheel.

14) The method of claim 13, wherein a trim layer is extended over the heater and the bag and the heater.

15) The method of claim 13, wherein the blower hood attachment, the blower hood, or both are connected to channels in the steering wheel.

16) The method of claim 15, wherein a distribution pipe extend between the channels and the blower hood attachment, the blower hood, or both.

17) The method of claim 13, wherein the distribution system is a plurality of discrete channels that extend at least partially through a foam layer of the steering wheel and the channels direct air to a location of interest.

18) The method of claim 17, wherein a plurality of holes are located in each of the channels and the plurality of holes extends all of the way through the foam layer.

19) The method of claim 13, wherein each of the plurality of blowers are connected to one or more distribution pipes and each of the one or more distribution pipes direct air between the distribution system and the plurality of blowers.

20) The method of claim 13, wherein the distribution system is a bag having a spacer disposed in the bag and creating an open space for air to move along the bag to a location of interest.
